(19) United States
(12) Patent Application Publication
(10) Pub. No.: US 2025/0093302 A1
(43) Pub. Date: Mar. 20, 2025

(54) ULTRASONIC FLAW DETECTION SYSTEM

(71) Applicant: Roger Dale REEVES, Cairo (EG)

(72) Inventor: Roger Dale REEVES, Cairo (EG)

(21) Appl. No.: 18/468,514

(22) Filed: Sep. 15, 2023

(51) Int. Cl. G01N 29/04; G01N 29/22; G01N 29/28

(52) U.S. Cl. CPC G01N 29/04; G01N 29/225; G01N 29/28; G01N 2291/023; G01N 2291/0289; G01N 2291/106

(57) ABSTRACT

A flaw detection system has a plurality of ultrasonic flaw detectors adapted to pass pulsed ultrasonic signals, a plurality of sequencing multiplexers electrically connected to the plurality of ultrasonic flaw detectors so as to receive the pulsed ultrasonic signals from the plurality of ultrasonic flaw detectors, a plurality of gain control modules connected to the plurality of sequencing multiplexers, a plurality of transducer assemblies respectively connected to an output of the plurality of gain control modules. The plurality of transducer assemblies are adapted to pass the pulsed ultrasonic signals from the plurality of sequencing multiplexers toward an object to be inspected. The plurality of transducer assemblies receives signals from the object to be inspected and passes the received signal back to the plurality of ultrasonic flaw detectors. The gain control modules has outputs to the transducer assembly that is a multiple of the inputs from the sequencing multiplexer.

### FIELD OF THE INVENTION

The present invention relates to the ultrasonic inspection of articles. More particularly, the present invention relates to the ultrasonic inspection for flaws in tubulars.

### BACKGROUND OF THE INVENTION

Of all of the applications of industrial ultrasonic testing, flaw detection is the oldest and the most common. Since the 1940s, the laws of physics that govern the propagation of sound waves through solid materials have been used to detect hidden cracks, voids, porosity, and other internal discontinuities in metals, composites, plastics, and ceramics. High-frequency sound waves reflect from flaws in predictable ways, producing distinctive echo patterns that can be displayed and recorded by portable instruments. Ultrasonic testing is completely nondestructive and safe. It is a well-established test method in many basic manufacturing, process, and service industries, especially in applications involving welds and structural metals.

The basic theory of ultrasonic inspection is that sound waves are simply organized mechanical vibrations traveling through a medium. This medium can be a solid, a liquid, or a gas. These waves travel through a given medium at a given at a specific speed or velocity, in a predictable direction. When they encounter a boundary with a different medium they will be reflected or transmitted according to simple rules.

All sound waves oscillate at a specific frequency, or number of vibrations or cycles per second, which humans experience as “pitch” in the familiar range of audible sound. Human hearing extends to a maximum frequency of about 20,000 cycles per second, while the majority of ultrasonic flaw detection applications utilize frequencies between 500,000 and 10,000,000 cycles per second. At frequencies in the megahertz range, sound energy does not travel efficiently through air or other gases, but it travels freely through most liquids and common engineering materials.

The speed of a sound wave varies depending on the medium through which it is traveling, affected by the medium's density and elastic properties. Different types of sound waves will travel at different velocities. Any type of wave will have an associated wavelength, which is the distance between any two corresponding points in the wave cycle as it travels through a medium. Wavelength is a limiting factor that controls the amount of information that can be derived from the behavior of a wave. In ultrasonic flaw detection, the generally accepted lower limit of detection for a small flaw is one-half wavelength. Anything smaller than that will be invisible.

Sound waves in solids can exist in various modes of propagation that are defined by the type of motion involved. Longitudinal waves and shear waves are the most common modes employed in ultrasonic flaw detection. Surface waves and plate waves are also used on occasion. A longitudinal or compressional wave is characterized by particle motion in the same direction as wave propagation, as from a piston source. Audible sound exists as longitudinal waves. A shear or transverse wave is characterized by particle motion perpendicular to the direction of wave propagation. A surface wave has an elliptical particle motion and travels across the surface of a material, penetrating to a depth of approximately one wavelength. A plate wave is a complex mode of vibration in thin plates where material thickness is less than one wavelength and the wave fills the entire cross-section of the medium. Sound waves may be converted from one form to another. Most commonly, shear waves are generated in a test material by introducing longitudinal waves at a selected angle.

The distance that a wave of a given frequency and energy level will travel depends on the material through which it is traveling. As a general rule, materials that are hard and homogenous will transmit sound waves more efficiently than those that are soft and heterogenous or granular. Three factors affect the distance a sound wave will travel in a given medium: beam spreading, attenuation, and scattering. As the beam travels, the leading edge becomes wider, the energy associated with the wave is spread over a larger area, and eventually the energy dissipates. Attenuation is energy loss associated with sound transmission through a medium, essentially the degree to which energy is absorbed as the wave front moves forward. Scattering is a random reflection of sound energy from grain boundaries and similar microstructures. As frequency goes down, beam spreading increases, but the effects of attenuation and scattering are reduced.

When sound energy traveling through a material encounters a boundary with another material, a portion of the energy will be reflected back and a portion will be transmitted through. The amount of energy reflected, or reflection coefficient, is related to the relative acoustic impedance of the two materials. Acoustic impedance is a material property defined as density multiplied by the speed of sound in a given material. For the metal/air boundaries commonly seen in ultrasonic flaw detection applications, the reflection coefficient approaches 100%. Virtually all of the sound energy is reflected from a crack or other discontinuity in the path of the wave. This is the fundamental principle that makes ultrasonic flaw detection possible.

Sound energy at ultrasonic frequencies is highly directional and the sound beams used for flaw detection are well defined. In situations where sound reflects off of a boundary, the angle of reflection equals the angle of incidence. A sound beam that hits a surface at a perpendicular incidence angle will reflect straight back. A sound beam that hits a surface at an angle will reflect forward at the same angle. Sound energy that is transmitted from one material to another bends in accordance with Snell's Law of Refraction.

In the broadest sense, a transducer is a device that converts energy from one form to another. Ultrasonic transducers convert electrical energy into high-frequency sound energy and vice versa. Typical transducers for ultrasonic flaw detection utilize an active element made of a piezoelectric ceramic, composite, or polymer. When this element is excited by high-voltage electrical pulse, it vibrates across a specific spectrum of frequencies and generates a burst of sound waves. When it is vibrated by an incoming sound wave, it generates an electrical pulse. The front surface of the element is usually covered by a wear plate that protects it from damage. The back surface is bonded to a backing material that mechanically dampens vibrations once the sound generation process is complete. Because sound energy at ultrasonic frequencies does not travel efficiently through gases, a thin layer of coupling liquid (a couplant) or gel is normally used between the transducer and the test piece.

Modern ultrasonic flaw detectors are small, portable, microprocessor-based instruments suitable for both shop and field use. They generate and display an ultrasonic waveform that is interpreted by a trained operator, often with the aid of analysis software, to locate and categorize flaws in test pieces. They will typically include in ultrasonic pulser/receiver, hardware and software for signal capture and analysis, a waveform display, and a data logging module. While some analog-based flaw detectors are still manufactured, most contemporary instruments use digital signal processing for improved stability and precision. The pulser/receiver section is the ultrasonic front end of the flaw detector. It provides an excitation pulse to drive the transducer, along with amplification and filtering for the returning echoes. Pulse amplitude, shape and damping can be controlled to optimize transducer performance. Receiver gain and bandwidth can be adjusted to optimize signal-to-noise ratios.

Modern flaw detectors typically capture a waveform digitally and then perform various measurement and analysis functions on it. A clock or timer will be used to synchronize transducer pulses and provide distance calibration. Signal processing may be as simple as generation of a waveform display that shows signal amplitude versus time in a calibrated scale, or as complex as sophisticated digital processing algorithms that incorporate distance/amplitude correction and trigonometry calculations for angled sound paths. Alarm gates are often employed to monitor signal levels at selected points in the wave train to flag echoes from flaws. The display may be a CRT, a liquid crystal display, or an electroluminescent display. The screen will typically be calibrated in units of depth or distance. Multicolor displays can be used to provide interpretive assistance. Internal data loggers can be used to record full waveform and set up information associated with each test.

Ultrasonic flaw detection is basically a comparative technique. Using appropriate reference standards along with a knowledge of sound wave propagation and generally accepted test procedures, a trained operator identifies specific echo patterns corresponding to the echo response from acceptable parts and from parts having representative flaws. The echo pattern from a test piece can then be compared to the patterns from these calibration standards to determine its condition.

Straight beam testing utilizing contact, delay line, dual element, or immersion transducers, is generally employed to find cracks or delaminations parallel to the surface of the test piece, as well as voids and porosity. It utilizes the basic principle that sound energy traveling through a medium will continue to propagate until it either disperses or reflects off a boundary with another material, such as the air surrounding a far wall or found inside a crack. In this type of test, the operator couples the transducer to the test piece and locates the echo returning from the far wall of the test piece, and then looks for any echoes that arrive ahead of the back wall echo, discounting grain scatter noise, if present. An acoustically significant echo that precedes the back wall echo implies the presence of a laminar crack or void. To further analysis, the depth, size and shape of the structure producing the reflection can be determined. In some specialized cases, testing is performed in a through transmission mode, where sound energy travels between two transducers placed on opposite sides of the test piece. If a large flaw is present in the sound path, the beam will be obstructed and the sound pulse will not reach the receiver.

Cracks or other discontinuities perpendicular to the surface of a test piece, or tilted with respect to that surface, are usually invisible with straight beam test techniques because of their orientation with respect to the sound beam. Such defects can occur in welds, in structural metal parts, and in many other critical components. In order to find them, angle beam techniques are used, employing either common angle beam transducer assemblies or immersion transducers aligned so as to direct sound energy into the test piece at a selected angle. The use of angle beam testing is especially common in weld inspection. Typical angle beam assemblies make use of Snell's Law to generate a shear wave at a selected angle in the test piece. As the angle of an incident longitudinal wave with respect to a surface increases, an increasing portion of the sound energy is converted to a shear wave in the second material. If the angle is high enough, all of the energy in the second material will be in the form of shear waves. This has two advantages in designing common angle beams to take advantage of this mode conversion phenomenon. First, energy transfer is greater at the incident angles that generate shear waves in steel and similar materials. Second, minimum flaw size resolution is improved through the use of shear waves, since at a given frequency, the wavelength of a shear wave is approximately 60% of the wavelength of a comparable longitudinal wave. The angled sound beam is highly sensitive to cracks perpendicular to the far surface of the test piece or, after bouncing off the far side, to cracks perpendicular to the coupling surface. A variety of specific beam angles and probe positions are used to accommodate different part geometries and flaw types.

An ultrasonic sequencing multiplexer is an instrument that allows a single ultrasonic flaw detector to perform like multiple individual instruments (typically four or eight or more instruments). When an ultrasonic flaw detector is connected to a multi-channel sequencing multiplexer, the sequencing ultrasonic multiplexer allows a single ultrasonic flaw detector to perform like multiple individual instruments. The total Pulse Repetition Frequency of the flaw detector that is connected to the sequencing multiplexer is divided by the number of activated channels of the multiplexer. For example, if a flaw detector pulse repetition frequency is adjusted to 8000 pulses per second, then each channel of an eight-channel sequencing multiplexer will pulse each ultrasonic transducer that is connected to it 8000 PRF divided by eight channels so as to equal 1000 PRF per transducer per second. Some multiplexers may be used in a sequencing pulsing mode or in a parallel pulsing mode, but not at the same time. Each individual channel of an ultrasonic multiplexer is connected to an individual ultrasonic transducer located in a transducer inspection assembly.

FIG. 2 describes a transducer inspection assembly 100. This is a single assembly that contains up to thirty-two angle beam transducers and eight wall thickness compression wave transducers. The transducer inspection assembly 100 maintains constant contact with an outside surface 102 of a tubular 104. This facilitates the transfer of ultrasonic waves into and out of the wall of the tubular 104. The assembly has water ports 106 that are used to supply the water that is used as a couplant. The water ports 106 are used to provide the water couplant that facilitates transfer of the ultrasonic wave into and out of the wall of the tubular 104 during an inspection scanning. The transducer inspection assembly 100 has a contour 108 that fits the nominal outside diameter 102 of the tubular 104. Various other types of transducer inspection assemblies can be used with multiple smaller individual elements, wheel-type transducer assemblies, immersion membrane types, etc.

Present ultrasonic full body inspection systems typically either function utilizing a movable frame or an overhead beam that propels the transducer inspection assemblies along an upper section of the tubular that is rotating in place or the tubular helixes through fixed transducer inspection assemblies.

FIG. 1 illustrates a prior art ultrasonic inspection system 1a. The system 1a contains a plurality of ultrasonic flaw detectors 3, 4, 5, 6, 7, 8, 9 and 10, a plurality of multiplexers 12, 13, 14, 15, 16, 17, 18 and 19 and transducer inspection assemblies 21, 22, 23, 24, 25, 26, 27 and 28. Lines 2 connect ultrasonic flaw detectors 3, 4, 5, 6, 7, 8, 9 and 10 to a strip chart recorder 1. Cables 11 connect the ultrasonic flaw detectors 3, 4, 5, 6, 7, 8, 9 and 10 to the multiplexers 12, 13, 14, 15, 16, 17, 18 and 19. A plurality of lines 20 connect the multiplexers 12, 13, 14, 15, 16, 17, 18 and 19 to the transducer assemblies 21, 22, 23, 24, 25, 26, 27, and 28, respectively. As can be seen, this inspection system 1a utilizes eight sets of ultrasonic flaw detectors, multiplexers and transducers. These eight sets are used to scan for transverse, longitudinal and oblique angled flaws from opposite sides of a flaw of a tubular.

An ultrasonic flaw detector, multiplexer, transducer inspection assembly that utilizes ultrasonic compression waves for the detection of wall thinning can be added to the ultrasonic inspection system 1a of FIG. 1. The helix of the wall thickness transducer inspection assembly will typically match the helix of the transducer inspection assemblies that are used for flaw detection. In some cases, the ultrasonic wall thickness detection is not required to be 100%. Flaw detection utilizes a shear wave ultrasonic beam, often referred to as angle testing, while wall thickness inspection utilizes compression wave beams.

It is important to note that when using the prior art of FIG. 1, the refracted angle selected will ensure that the entire area of the ultrasonic angle beam intersects the internal diameter of the wall curvature when scanning for longitudinal and oblique flaws. The refracted angle does not have to be the same for each individual set when using the method of FIG. 1. When the multiplexers 12, 13, 14, 15, 16, 17, 18 and 19 pulse in sequence or parallel modes, the helix path of each transducer inspection assemblies 21, 22, 23, 24, 25, 26, 27 and 28 is determined by the number of transducers and the effective beam width of the transducers that are utilized in the transducer inspection assembly that is connected to a particular multiplexer. Therefore, the helix path is still the same regardless of whether the sequence or parallel mode is used.

Depending on the effective beam width that is used for the selected transducer, the helix path of a transducer inspection assembly that would, for example, use eight 0.5 inch transducers with an effective beam width of 0.375″ produces a helix path per revolution of three inches. Larger diameter and paintbrush transducers will, of course, have larger effective beam widths. Larger diameter transducers may be selected for use for transverse and oblique flaw scanning when inspecting larger diameter tubulars.

In FIG. 1, each transducer inspection assembly 21, 22, 23, 24, 25, 26, 27 and 28 is used to detect an orientation of a flaw from opposite sides of each wall when inspecting tubular 41. Transducer inspection assembly 21 is used to scan the transverse flaw 29 from one side 30. Transducer inspection assembly 22 is used to scan a transverse flaw 29 from an opposite side 31. Transducer inspection assembly 23 is used to scan a longitudinal flaw 32 from side 33. Transducer inspection assembly 24 is used to scan the longitudinal flaw 32 from an opposite side 34. Transducer inspection assembly 25 is used to scan a counterclockwise oblique flaw 35 from one side 36. Transducer inspection assembly 26 is used to scan the counterclockwise oblique flaw 35 from an opposite side 37. Transducer inspection assembly 27 is used to scan a clockwise oblique flaw 38 from one side 39. Transducer inspection assembly 28 is used to scan the clockwise oblique flaw 38 from an opposite side 40.

This prior art “stand-alone” ultrasonic full body inspection system 1a that uses eight sets, as shown in FIG. 1, and that of the present invention, which only uses one new set that has the same pulse density and scan time for the same size and length of tubular when using the same effective beam width, revolutions per minute, number and size of transducers and other operating parameters. It is common for the inspection system 1a to use only four sets to scan for transverse flaws and longitudinal flaws in the manner shown in FIG. 3. In FIG. 3, it can be seen that there are ultrasonic flaw detectors 53, 54, 55 and 56 that are connected by lines 52 to strip chart recorder 51. Ultrasonic flaw detectors 53, 54, 55 and 56 are connected by cables 57. Sequencing multiplexers 58, 59, 60 and 61 will be connected by lines 64 to ultrasonic inspection assemblies 66, 68, 70 and 71.

The system 72, as shown in FIG. 3, does not require oblique flaw inspections. This ultrasonic full body inspection system 72 typically utilizes a total of thirty-two ultrasonic transducers for flaw detection and eight transducers for wall thickness inspection (not shown). This is the more common type of ultrasonic full body inspection system that is utilized by inspection agencies when inspecting tubulars that have been received from manufacturers of the tubulars.

In FIG. 3, each of the ultrasonic flaw detectors 53, 54, 55 and 56 has at least two flaw gate alarms, a 400-volt pulser and a signal output to the strip chart display 51. The transducer inspection assembly 66 detects a transversely-oriented flaw 77 on an oilfield tubular 74 from a side 78. Transducer inspection assembly 68 serves to detect the transversely-oriented flaw 77 on the tubular 74 from an opposite side 79. Transducer inspection assembly 70 detects a longitudinally-oriented flaw 80 from a side 81. The ultrasonic inspection assembly 71 detects the longitudinal flaw 80 from an opposite side 82.

FIG. 4 shows a prior art multifunction flaw detection system 110 of U.S. Pat. No. 11,493,319 of the present inventor. In particular, there is a helixing conveyor 112 that is adapted to receive a tubular thereon. The helixing conveyor 112 has an entry section 114, a center section 116 and an exit section 118. The helixing conveyor 112 includes a plurality of sets of rollers 120, 122, 124, 126 and 128. Each of the sets of rollers 120, 122, 124, 126 and 128 is angularly adjustable relative to a longitudinal axis of the helixing conveyor 112. The set of rollers 120 is positioned on a base plate 130. The set of rollers 128 is also positioned on a base plate 132. An actuator 134 connects with the base plates 130 and 132 so as to move the sets of rollers 120 and 128 between an orientation transverse to a longitudinal axis of the helixing conveyor 112 to a position angularly offset from this orientation transverse to the longitudinal axis of the helixing conveyor 112. FIG. 4 further shows that rollers 122, 124 and 126 include actuators 136, 138 and 140 which act on the rollers 122, 124 and 126, respectively, so as to open and close the rollers upon the entry of the tubular into the center section 116.

A frame 142 is positioned over the center section of the helixing conveyor 112. A plurality of inspection devices (such as these of the present invention) will be retained by this frame so as to detect flaws in the tubular as the helixing conveyor 112 moves the tubular through the frame 142.

In FIG. 4, the entry section 114 can be raised or lowered, as desired. As such, the entry section 112 can be lowered so as to allow the tubular to be loaded onto the set of rollers 120. Alternatively or in conjunction with the raising and lowering of the entry section 114, the center section 116 and the exit section 118 can also be raised or lowered as desired. A grade comparator coil 142 is positioned in the center section 116 adjacent to the entry section 114. The grade comparator coil 142 will have an opening therein which allows the tubular to pass therethrough. The longitudinal inspection housing 144 is located downstream from the comparator coil 142. The oblique inspection housing 146 is positioned within frame 142 and located further downstream from the longitudinal inspection housing. The transverse inspection housing 148 will be positioned in the frame 142 and located further downstream from the oblique inspection housing 146.

The center section 116 will contain the entire inspection function stations 142, 144, 146 and 148. The center section 116 can mechanically raise or lower the various magnets and detectors in order to vertically center these magnets and detectors for different size tubulars. Between the individual inspection function housings 144, 146 and 148, there are vertical or horizontal-mounted mechanically adjustable and mechanically-powered helix rollers 136, 138 and 140. These can be photocell or mechanically-operated devices that close the helix rollers as the tubular enters each assembly and then opens as the tubular exits each of the inspection housings.

It is an object of the present invention to provide an ultrasonic flaw inspection system that the reduces the number of flaw detectors and multiplexers required.

It is another object of the present invention to provide an ultrasonic flaw detection system that is less expensive.

It is another object of the present invention to provide an ultrasonic flaw detection system which is compact.

It is another object of the present invention to provide an ultrasonic inspection system that allows for the use of sequencing and parallel pulsing of multiple ultrasonic transducers.

It is another object of the present invention to provide an ultrasonic flaw detection system that allows for the inspection of tubular goods.

It is another object of the present invention to provide an ultrasonic flaw detection system that offers the same detection results and same production rate as the prior art.

It is a further object of the present invention to provide an ultrasonic flaw detection system which allows a single flaw detector to operate in the same manner as eight or more individual instruments.

It is a further object of the present invention to provide an ultrasonic flaw detection system which allows the end-user more options when specifying inspection functions.

It is a further object of the present invention to provide an ultrasonic flaw detection system in which the entire system is contained in a single fixture or a plurality of individual overlapping fixtures.

These and other objects and advantages of the present invention will become apparent from a reading of the attached specification and appended claims.

### BRIEF SUMMARY OF THE INVENTION

The present invention is a flaw detection system that comprises a plurality of ultrasonic flaw detectors adapted to pass pulsed ultrasonic signals, a plurality of sequencing multiplexers electrically connected to the plurality of ultrasonic flaw detectors so as to receive the pulsed ultrasonic signals from the plurality of ultrasonic flaw detectors, and a plurality of transducer assemblies respectively connected to an output of the plurality of sequencing multiplexers. The plurality of transducer assemblies are adapted to pass the pulsed ultrasonic signals from the plurality of sequencing multiplexers toward an object to be inspected. The plurality of transducer assemblies receive signals from the object and pass the received signals back to the plurality of ultrasonic flaw detectors.

A multi-channel strip chart recorder is connected to the plurality of ultrasonic flaw detectors. The multi-channel strip chart recorder produces a humanly-perceivable indication of a flaw in the object to be inspected. Each of the plurality of ultrasonic flaw detectors has a first alarm gate and a second alarm gate. The first alarm gate reacts to a first condition in the object to be inspected. The second alarm gate reacts to a second condition in the object to be inspected. In the preferred embodiment of the present invention, the first condition is an external flaw in the object to be inspected. The second condition is an internal flaw in the object to be inspected. Alternatively, the first condition can be an thickness of the object to be inspected. The second condition can be another thickness in the object to be inspected. The pulsed ultrasonic signals are adjustable to at least 400 volt pulsed signals.

The plurality of ultrasonic flaw detectors comprise at least two detectors. The plurality of ultrasonic flaw detectors each has a line extending to the multi-channel strip chart recorder. The plurality of sequencing multiplexers comprise at least two multiplexers. Each of the two multiplexers is connected by cable to each of the plurality of ultrasonic flaw detectors. Each of the plurality of sequencing multiplexers has a gain control module passing the pulsed ultrasonic signal into a plurality of multi-channel parallel pulses to the plurality of transducer assemblies. The plurality of multi-channel parallel pulses comprise at least eight outputs from the gain control module. The plurality of transducer assemblies comprise at least four transducer assemblies. Each of the four transducer assemblies directs the eight outputs from the gain control modules toward the object to be inspected. The plurality of multi-channel parallel pulses have the same size and have identical incident angles and identical refraction angles with respect to the object to be inspected.

In the preferred embodiment of the present invention, the object to be inspected is a tubular. The flaw detection system further comprises a couplant directed to a surface of the tubular in an area between the plurality of transducer assemblies and the surface of the tubular. A helixing conveyor receives the tubular thereon. The helixing conveyor is adapted to rotate the tubular as the plurality of transducer assemblies directly pulse ultrasonic signals toward the tubular. The received signals from the tubular are indicative of a flaw in an external surface of the tubular or a flaw in the internal surface of the tubular. The flaw in the external surface of the tubular of the flaw in the internal surface of the tubular can be a transverse flaw or a longitudinal flaw in the tubular.

The present invention is also a system for detecting a flaw in a tubular. The system comprises a helixing conveyor adapted to rotate the tubular, a plurality of ultrasonic flaw detectors positioned away from the helixing conveyor, a plurality of sequencing multiplexers electrically connected respectively to the plurality of gain control modules so as to receive the pulsed ultrasonic signals from the plurality of transducer assemblies, and a plurality of transducer assemblies respectively connected to an output of the plurality of gain control modules. The helixing conveyor has a surface upon which the tubular is removably placed. The plurality of transducer assembling are adapted to pass ultrasonic signals from the surface of the tubular on the helixing conveyor. The plurality of gain control modules pass the pulsed ultrasonic signals from the plurality of sequencing multiplexers to the surface of the tubular. The plurality of transducer assemblies receive signals reflected from the tubular and pass these received signals to the plurality of ultrasonic detectors. The plurality of sequencing multiplexers has an input corresponding to a number of the plurality of ultrasonic detectors. The output of the plurality of sequencing multiplexers is a multiple of the number of the plurality of ultrasonic flaw detectors.

A multi-channel strip recorder is connected to the plurality of ultrasonic flaw detectors. The multichannel strip chart recorder produces a humanly-perceivable indication of a flaw on the surface of the tubular. The helixing conveyor rotates the tubular as the plurality of transducer assemblies directs the pulsed ultrasonic signals toward the surface of the tubular.

The present invention is a cost-effective and compact means of utilizing various ultrasonic inspection components that can be configured to function as a sequencing “and” parallel type of pulsing of multiple ultrasonic transducers rather than the prior art sequencing “or” parallel type pulsing of multiple ultrasonic transducers for the inspection of tubular goods. It can also be used for other types of material such as plates, tanks, etc.

The system of the present invention reduces the eight sets of flaw detectors and multiplexers of the prior art to only one new set. This is achieved by employing inexpensive but effective gain control modules. Each new set of the present invention will still provide the same flaw detection results as well as the production rate as the eight sets of the prior art.

The gain control modules in the transducer inspection assemblies will contain eight transducers. The number of channels on the gain control module will increase depending on the ability of the selected flaw detector to successfully pulse a higher number of particular types of transducers. Since each channel of the gain control module is connected to an individual channel of the gain control module, the number of transducers per transducer inspection assembly will increase accordingly. Conversely, if utilizing paintbrush transducers, the number of channels per gain control module and transducer inspection assembly may decrease.

When configuring the transducers for parallel pulsing, there may be instances where two separate flaws intersect two transducers in the transducer inspection assembly. This can cause the flaw reflector to appear larger in amplitude. In the present invention, it is better to periodically prove of and accept flaws that are detected due to flaw detector gain increase or that is due to two or more transducer intersecting multiple flaws at the same time, than to miss a rejectable flaw that can evolve into a catastrophic failure during installation on a rig, during production in a well, or in a pipeline.

The present invention reduces the present eight sets illustrated in FIG. 1 to just one new set by simply inserting a multichannel parallel-pulsing gain control module between each individual channel of the ultrasonic sequencing multichannel multiplexer and each of the transducer inspection assemblies that are used for the detection of a particular orientation of a flaw. The gain control module simply uses the same type of circuitry that is used on a standard multiplexer. Since only the gain control electronic circuitry section of the multiplexer is used, the size and cost of the gain control module is a fraction of an entire multiplexer.

The transducer inspection assembly rides on the tubular's surface and sends and receives ultrasonic waves into the body wall of the tubular in order to scan for a particular orientation of a flaw or for wall thinning. The transducer arrangement of each of the transducer inspection assemblies will be in a known fashion that decreases the chance of two or more transducers intersecting a flaw at the same time. The flaw detector uses an ultrasonic cable and one ultrasonic transducer to inspect for flaws on the material. The ultrasonic sequencing multiplexer allows the single flaw detector to perform in the manner of eight or more individual instruments. Regardless of whether immersion-type transducers or contact-type transducers are utilized in the present invention, it is necessary that all the angle beam transducers used for flaw detection are located in each transducer inspection assembly be of the same type, size, frequency, incident angle, refracted angle, shape and manufacturer. Whether contact or immersion transducers are utilized, the distance from the center of the transducer face to the beam index point on the outside surface of the tubular will be the same for all the angle beam transducers used for scanning of transverse, longitudinal or oblique-oriented flaws. When utilizing transducer inspection assemblies in which the incident angle of each individual transducer can be adjusted, the type, size, frequency, incident angle, refracted angle, shape, manufacturer and index point would be the same. Only incident angles are used to ensure that the entire angle beam intersects the internal diameter of the wall curvature and scanning for longitudinal and oblique flaws. This will allow all the various orientation of flaws, whether internal or external, to be displayed with the appropriate alarm gate.

In the present invention, a single flaw detector with at least two alarm gates and an internal pulser (that can be adjusted up to at least 400 volts) is connected to a single multi-channel ultrasonic sequencing multiplexer. Each channel of the sequencing ultrasonic multiplexer can be connected to a single ultrasonic connection on the back of a gain control module. The gain control module's single connector is internally connected in parallel and split (via eight individual electronic gain control circuits) to eight or more signal connectors on the front panel of the gain control module. In addition to the gain control adjustment of the flaw detector, each channel of the multiplexer has a gain control adjustment, damping control and a sequencing control and channel selector control function. Each channel of the gain control module has a gain control function. Each one of the eight or more connectors on the front of the gain control module is connected to a transducer inspection assembly. After the initial gain adjustment of the flaw detector, the gain controls of the multiplexer and the gain control module can be used to set each individual transducer to the equal screen height on the flaw detector's display in the chart recorder display.

The flaw detector will pulse the sequencing ultrasonic multiplexer. Each time the sequencing multiplexer pulses on channel one that is connected to the multiplexers channel one will send the pulse at the same time to all the eight ultrasonic transducers that are located in the transducer inspection assembly. When the transducer inspection assembly that is connected to the multiplexer channel one detects an internal or external flaw that is of particular orientation on a tubular, the reflected signal is returned via the gain control module to channel one of the multiplexer into the flaw detector and onto the chart recorder (if the threshold on one of the flaw detector gates is exceeded). One gate of the flaw detector is used to display, trigger and alarm for external flaws while the other gate displays, triggers and alarms for internal flaws. The sequencing multiplexer then sequences to channel two and repeats this process. Channels three through eight will continue sequencing until the sequence returns to channel one to continue the sequencing process. In this manner, each channel of the new set eight-channel sequencing multiplexer replaces one of the prior art sets by inserting the gain control modules.

Since all of the angle beam transducers are of the same type, size, frequency, incident angle, refracted angle, shape and manufacturer, the gain control of the flaw detector can be used to position the flaw signal reflectors from a man-made artificial precision calibration notch or through a drilled hole to approximately 50% of the full screen height. The inspection personnel can then use the individual channel gain control on channel one of the multiplexer and the individual gain control of the corresponding gain control module's channel one to adjust the screen height to just above the screen height of each of the two flaw alarm gates. The process is then repeated on channels two through eight of the gain control modules channel one. The process is continued until all of the individual channels of the angle sequencing multiplexer and each of the channels of the gain control modules two through eight are completed. In this manner, all of the received reflections from all of the transducers in each transducer inspection assembly will be adjusted to the same screen height of each gate of the flaw detector and displayed to the same level on the chart recorder. Flaw gate width is typically set more than wide enough to compensate for the allowable variations of wall thickness.

On new tubulars, the wall thickness is allowed to decrease up to 12.5% of the nominal wall thickness of a particular size and weight per foot and still be acceptable for use as long as the remaining body wall thickness exceeds 87.5% of the nominal wall thickness. The variation in the wall thickness should be covered by the widths of the internal gate and the external gate. The two alarm gate widths are typically extended to cover for the allowable increase in wall thickness that may occur. The width of the two alarm gate should not overlap each other in order to preserve internal and external flaw differentiation.

If an automatic marking system is not employed during the scanning process, the inspection personnel can stop and back up on the detected deformation. The multiplexer's alarm signal will allow the inspection personnel to determine the specific multiplexer channel that detected the flaw. This will allow the inspection personnel to distinguish the orientation of the flaw prior to marking the location and the type of flaw adjacent to the flaw location on the surface of the tubular. This marking allows the personnel to locate and evaluate the flaw in accordance with API standards.

This foregoing Section is intended to describe, with particularity, the preferred embodiments of the present invention. It is understood that modifications to this preferred embodiment can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a schematic illustration of a prior art ultrasonic flaw detection system.

FIG. 2 is an upper perspective view showing the transducer assembly of the prior art as applied to a tubular.

FIG. 3 shows another ultrasonic inspection flaw detection system of the prior art.

FIG. 4 is a plan view showing an a helixing conveyor of the prior art.

FIG. 5 is a schematic showing the ultrasonic flaw detection system of the present invention in accordance with a preferred embodiment of the present invention.

FIG. 6 is a schematic illustration of the ultrasonic flaw detection system of the present invention in accordance with a first alternative embodiment of the present invention.

FIG. 7 is a schematic illustration of the ultrasonic flaw detection system of the present invention in accordance with a second alternative embodiment.

FIG. 8 is a schematic illustration of a third alternative embodiment of the ultrasonic inspection flaw detection system of the present invention in accordance with a third embodiment.

FIG. 9 is a schematic illustration of the ultrasonic flaw inspection system of the present invention in accordance with a fourth alternative embodiment.

### DETAILED DESCRIPTION OF THE INVENTION

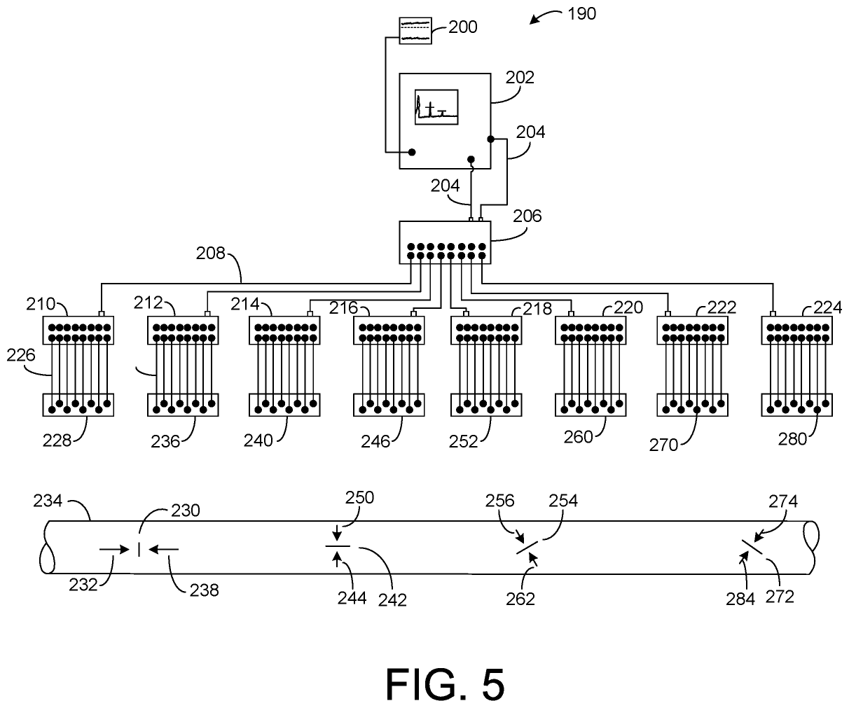

Referring to FIG. 5, there is shown the ultrasonic flaw inspection system 190 in accordance with a preferred embodiment of the present invention. In FIG. 5, there is a dual channel strip recorder 200 that is connected to a single flaw detector 202. The dual-channel strip chart recorder can be either paper or a computer screen. The ultrasonic flaw detector 202 will have at least two flaw alarm gates and at least a 400 volt pulser. Ultrasonic signal cables 204 connect the flaw detector 202 to an eight channel ultrasonic sequencing multiplexer 206. Eight individual ultrasonic signal cables 208 connect each channel of the sequencing multiplexer 206 (in particular channels one through eight) to a single pulse echo connector on the back of each of the eight gain control modules. The ultrasonic signal cables 208 are connected internally to the front of each of the eight gain control modules 210, 212, 214, 216, 218, 220, 222 and 224. Gain control unit 210 is connected via eight cables 226 to eight individual transducers contained in the transducer assembly 228 that are used for the detection of a transverse flaw 230 from a side 232 on tubular 234. The gain control unit 212 is connected the by cables 226 to the eight individual transducers contained in the transducer assembly 236. Transducer assembly 236 is utilized for the detection of the transverse flaw 230 from the opposite side 238. Gain control unit 214 is connected by cables 226 to the transducer assembly 240. Transducer assembly 240 is utilized for the detection of a longitudinal flaw 242 from one side 244. Gain control unit 216 is connected by cables 226 to the transducer assembly 246. Transducer 246 is used to detect longitudinal flaw 242 from opposite side 250. The gain control unit 218 is connected by cables 226 to eight individual transducers contained in the transducer assembly 252. Transducer assembly 252 is used for the detection of a counterclockwise-oriented flaw 254 on one side 256. Gain control unit 220 is connected by cables 226 to the transducer inspection assembly 260. Transducer inspection assembly 260 is used for the detection of a counterclockwise-oriented oblique flaw 262 on an opposite side thereof. Gain control unit 222 is connected by cables 226 to the eight individual transducers of the transducer assembly 270. Transducer assembly 270 is utilized for the detection of a clockwise-oriented flaw 272 from one side 274. The gain control unit 224 is connected by cables 226 to the eight individual transducers contained in the transducer assembly 280. Transducer assembly 280 is utilized for the detection of a clockwise-oriented oblique flaw 272 on an opposite side 284.

When comparing the pulse density and scan times of the prior art with respect to the present invention, as shown in FIG. 5, the inspection system 190 of FIG. 5 can be used to inspect a forty foot and five inch diameter tubular at the same 240 revolutions per minute of the prior art and at the same pulse repetition frequency of 10,000 on an eight channel sequencing multiplexer with the same 1250 pulses per second per channel. Dividing the same 62.84 scanned circumference surface per second by 1250 PRF per channel yields a pulse density of 0.0503 inches which is the same as the prior art. Using a 0.5 inch transducer with an effective beam width of 0.375 inches divided by the 0.0503 inch pulse density will equal 7.4 times each transducer pulses as the effective beam width of each transducer passes over a specific point of a flaw. Since each transducer inspection assembly contains eight transducers, all pulsing at the same time in parallel load, then the effective beam width of 0.375 inches times the eight transducers will equal a three inch helix per transducer inspection assembly. Spinning the tubular at the same four revolutions per second but times the three inch helix per transducer assembly will equal a twelve inch scan advancement per second. A 480″ tubular divided by twelve inch scan advancement per second will equal the same forty second scan time per 40 foot tubular or the equivalent of 60 feet movable linear advancement as in the prior art.

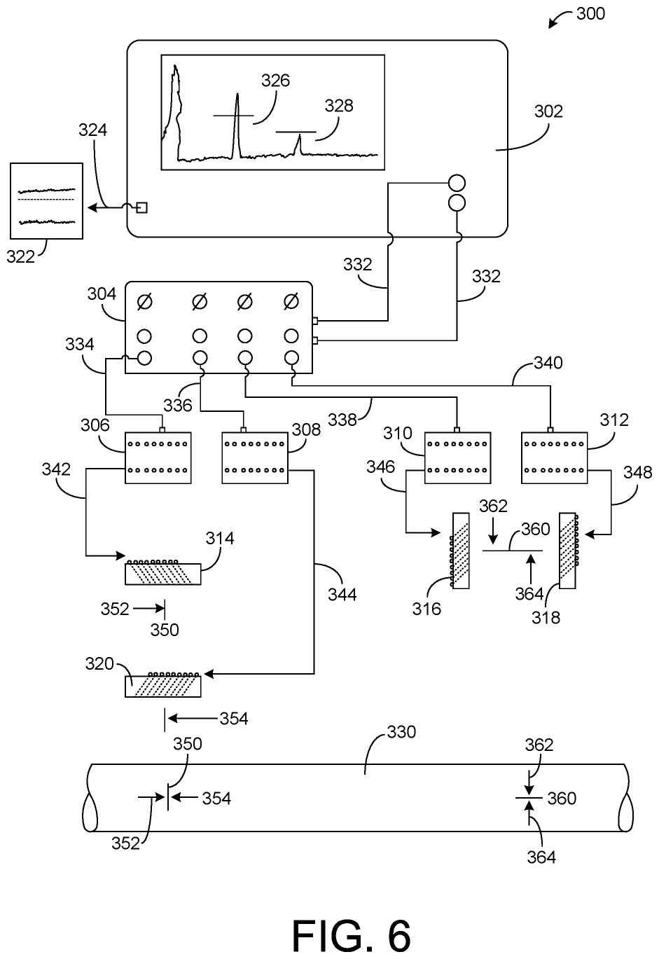

The system 190, as shown in FIG. 5 is a stand-alone ultrasonic full body inspection unit when scanning for only transverse flaws in longitudinal flaws and oblique flaws. FIG. 6 shows the system 300 of the present invention. System 300 has a single ultrasonic flaw detector 300, a four channel sequencing multiplexer 304, four individual gain control modules 306, 308, 310 and 312 and four transducer inspection assemblies 314, 316, 318 and 320. A dual-channel strip chart recorder 322 is connected to a single dual gate ultrasonic flow detector 302 via a single line 324.

The ultrasonic flaw detector 302 has at least two flaw alarm gates 326 and 328 and at least a 400-volt pulser. The flaw alarm gates 326 display external flaws in the tubular 330. Flaw alarm gates 328 displays internal flaws from the tubular 330. However, the alarm gates 326 and 328 can be suitably reversed depending upon the desires of the testing procedure.

Ultrasonic signal cables 332 connect the ultrasonic flaw detector 302 to the four channel ultrasonic sequencing multiplexer 304. Cable 334 connects one channel of the sequencing multiplexer 304 to the gain control module 306. Cable 336 connects another channel of the multiplexer 304 to the gain control module 308. Cable 338 connects another channel of the multiplexer 304 to the gain control module 310. Cable 340 connects a further channel of the multiplexer 304 to the gain control module 312.

Cable 342 connects the gain control module 306 to the first ultrasonic detector assembly 314. Cable 344 connects the gain control module 308 to the second ultrasonic transducer assembly 320. Cable 346 connects the gain control module 310 to the ultrasonic transducer assembly 316. Cable 348 connects the gain control module 312 to the ultrasonic transducer assembly 318. It should be noted that the cables 342, 344, 346 and 348 represent eight individual cables connecting each of the eight ultrasonic connectors on the front panel of the respective gain control modules 306, 308, 310 and 312 to each corresponding transducer in the ultrasonic transducer assemblies 314, 316, 318, and 320.

The ultrasonic transducer assembly 314 detects a transverse flaw 350 from one side 352. Ultrasonic transducer assembly 320 detects the longitudinal flaw 350 from an opposite side 354. Ultrasonic transducer assembly 316 detects a longitudinal flaw 360 on one side 362. Ultrasonic transducer assembly 318 detects the longitudinal flaw 360 from an opposite side 364.

The ability of electromagnetic inspection systems to detect internal flaws is degraded on thick wall tubulars. Tubulars used in oil and gas wells that are drilled near populated areas, or in offshore deepwater and other environmentally sensitive areas, require more sensitive and complete inspections. These types of tubulars are generally required to be inspected with ultrasonic full body inspection systems. In many instances, the inspection agency that is performing inspection services for an end-user may not have an ultrasonic full body inspection system available. The inspection system of the present invention allows the owner/end user of the tubulars a variety of options when specifying the types of inspection functions that the owner requires for a particular type of tubular. Other combinations of options could be used at the discretion of the inspection agency depending on the various types and categories of tubulars that are undergoing inspection.

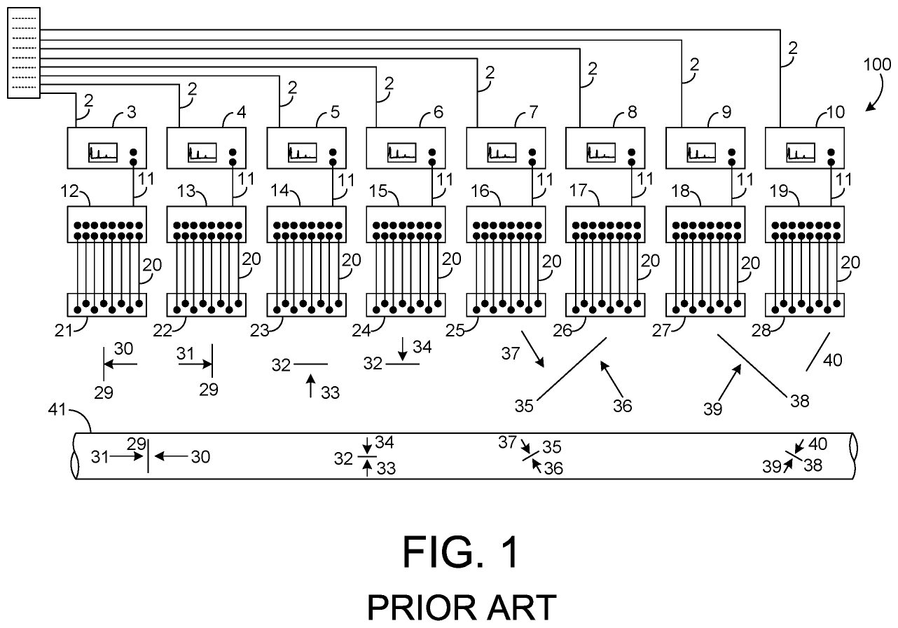

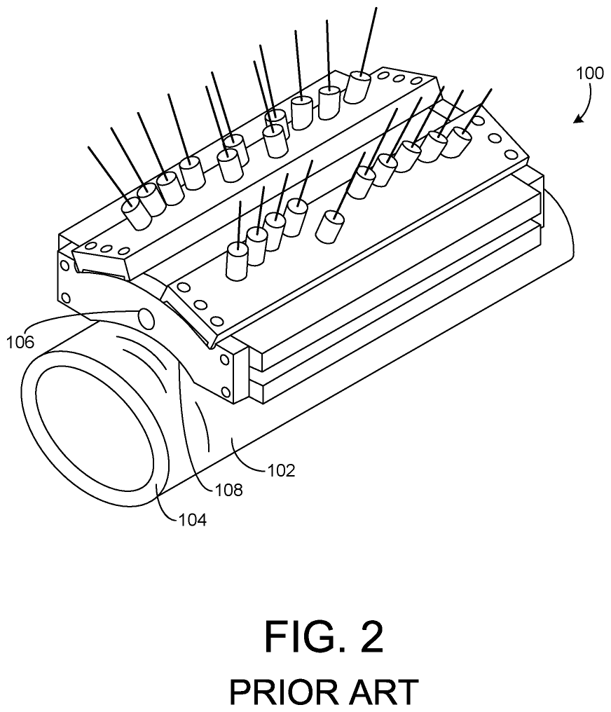

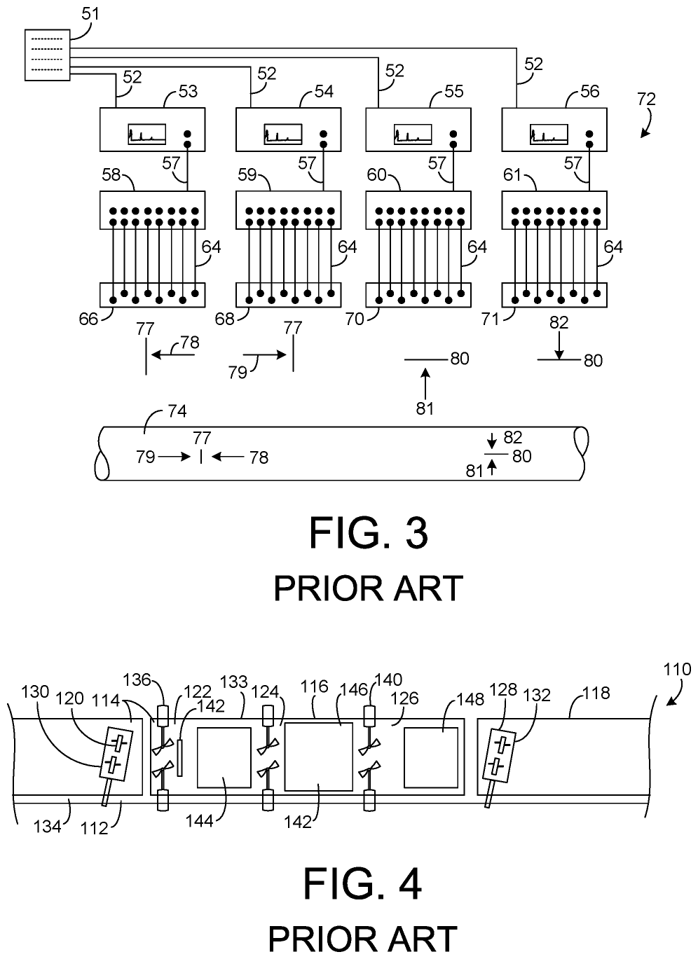

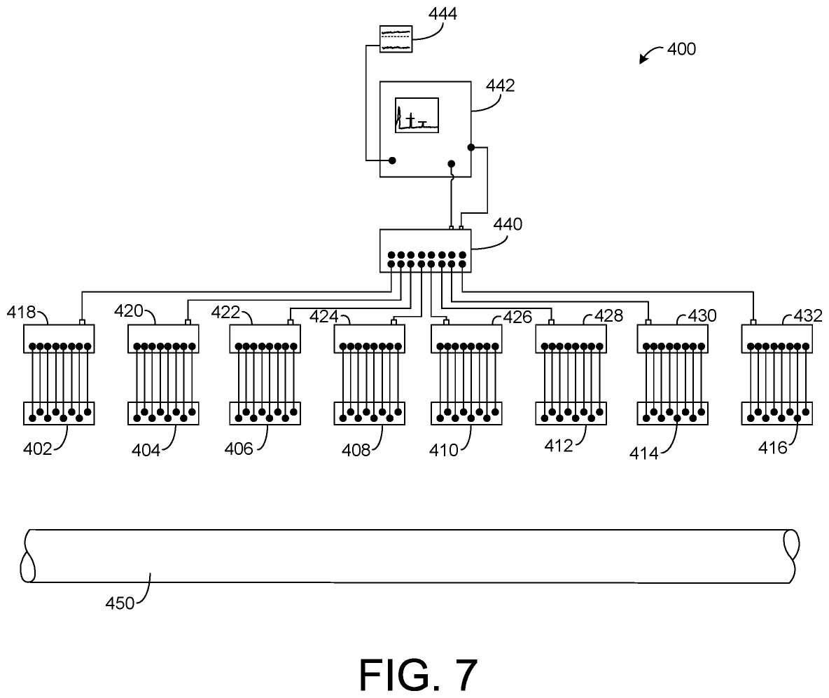

By adding one or more of the ultrasonic inspection functions of the present invention would create an Electromagnetic/Ultrasonic combination unit. This is desirable in the industry. The ultrasonic inspection system 400 as shown in FIG. 7 would provide a method to economically match the smaller helix typically used by ultrasonic full body inspection systems to the electromagnetic inspection unit's substantially larger helix. This larger helix is typically approximately nine inches when using eighty revolutions per minute and sixty feet movable linear conveyor speed. FIG. 7 illustrates how they system 400 can be set up to reduce the eight sets of flaw detector/multiplexers that are used in the prior art, as illustrated in FIG. 1, to a more compact and economical detector/multiplexer set combined with simple, economic gain control modules to create a new set. FIG. 7 illustrates how the four transducer inspection assemblies 402, 404, 406 and 408 each scan with a three inch helix for a total combined helix of twelve inches. They will scan for transverse flaws from one side while the other ultrasonic transducer assemblies 410, 412, 414 and 416 will scan for transverse flaws from the opposite side. The eight gain control modules 418, 420, 422, 424, 426, 428, 430 and 432 are compact and take up the same space in the operator compartment as two of the eight channel multiplexers. A second assembly, set up in the same manner as shown in FIG. 7, but with the transducer inspection assembly scanning for longitudinal flaws, can be added to the system 400 with the same twelve inch helix.

As with the system shown in the previous FIGS. 5 and 6, a single eight channel multiplexer 440 has lines connected to each of the gain control modules 418, 420, 422, 424, 426, 428, 430 and 432. The sequencing multiplexer 440 will be connected to the ultrasonic flaw detector 442. Ultrasonic flaw detector 442 is ultimately connected to the dual-channel strip recorder 444. FIG. 7 shows that the ultrasonic transducer assemblies 402, 404, 406, 408, 410, 412, 414 and 460 are directed so as to inspect the surface of the tubular 450. In particular, the transverse flaw is particularly inspected with the system shown in FIG. 7.

The longitudinal electromagnetic detectors will provide up to a fourteen inch helix path per revolution of the tubular. The adjustable helix path will allow the incorporation of these new sets with a twelve inch helix. When using ultrasonic scanning, the combination of the linear and rotational speed of the material and/or the scanner should provide 100% full-body coverage based on the effective beam width of the transducer and the distance between successive pulses of each instrument channel. Since the revolutions permitted of an electromagnetic inspection are typically limited to between eighty revolutions and one hundred revolutions per minute, the pulse density distance between successive pulses would be significantly reduced. This allows the ultrasonic transducer assembly to pulse more times on a flaw as the effective beam width crosses a flaw (when compared to the much higher revolutions per minute that are presently used in the prior art).

The transducer inspection assemblies are very compact and use minimal additional space in the center section of the helixing conveyor. This is especially true when the ultrasonic inspection assemblies are utilized on both the top and bottom of the helixing tubular. For example, if the transducer inspection assembly is used for transverse ultrasonic scanning, one or more transducer inspection assemblies can be used for transverse ultrasonic scanning on the bottom of the helixing conveyor while one or more longitudinal transducer inspection assemblies can be used on the top of the helixing conveyor. The versatility and the placement of these transducer inspection assemblies allows various options in the placement of the transducer inspection assemblies in order to achieve overlapping coverage of the various ultrasonic scanning assemblies. This also allows a reduced size of the water catch trough below the transducer inspection assemblies.

The transducer inspection assemblies and the water containment trough would be placed within the electromagnetic/ultrasonic unit on the exit side of the helixing conveyor. The tubular will helix through wipers and/or a medium-to high-pressure stream of air that will be located between the electromagnetic inspection assembly and the ultrasonic transducer inspection assembly of the unit. If the tubular is reversed during the inspection process, the airflow and/or wipers will isolate the water to the ultrasonic section of the electromagnetic/ultrasonic unit. The water that is captured by the trough during the scanning process will be recycled through filters and reused in the inspection process. This water will be the “couplant” as used in conjunction with the scanning process.

When inspecting the same tubular size and length and utilizing the same pulse repetition frequency, the number and size of transducers, and the effective beam width, but utilizing the reduced revolutions per minute will decrease the distance between successive pulses (i.e. pulse density) and increase the times that the transducer pulses on a flaw as the effective beam width as the transducer passes over the flaw when compared to the higher RPM that is used in the prior art. Since the present invention utilizes a larger helix per revolution that can be adjusted to twelve inches per revolution of the tubular, the revolutions per minute of the helixing tubular can be reduced to sixty revolutions per minute regardless of the outside diameter of the tubular. The slower sixty revolutions per minute more closely align with the scan speed of one foot per second used by the transverse assembly of a rotating head type electromagnetic unit that is used in the prior art.

The helix per revolution of the present invention, when using eight 0.5 inch angle beam transducers for detection from each side of a particular orientation of a flaw, is typically three inches or less. The helix per revolution of the various prior art systems will be approximately nine inches per revolution. Since the helixing conveyor system is known in the prior art and described, in particular, in association with U.S. Pat. No. 11,493,319 to the present inventor, one or more ultrasonic inspection assemblies can be utilized in the nature of FIG. 7 so as to be added to the existing inspection systems in the electromagnetic unit. This significantly reduces one of the major expenditures associated with inspection systems. The inspection system described in U.S. Pat. No. 11,493,319 utilizes an adjustable helixing conveyor system for the electromagnetic inspection functions that are used for the inspection of tubulars. The adjustable helix allows a larger or smaller helix. The electromagnetic inspection system of this patent to the present inventor uses wider stationary non-rotating electromagnets that allow for a lower revolutions per minute while helixing the tubular. The wider electromagnets in conjunction with the use of individual pulse density will vary. Other combinations of revolutions per minute and adjustable helix widths in conjunction with different types and sizes of transducers or adjusting the effective beam width will allow greater versatility.

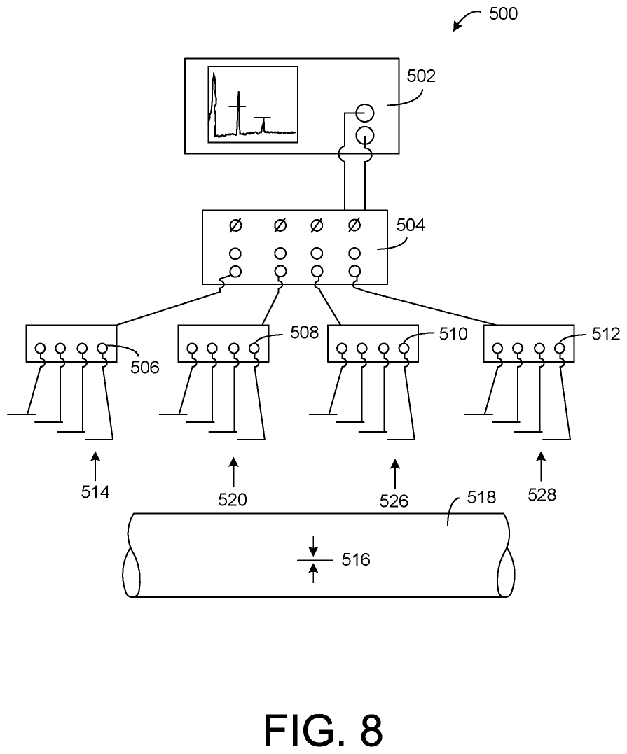

FIG. 8 shows an alternative ultrasonic flaw detection system 500 employing the present invention. As with the previous embodiments, the ultrasonic inspection detection system 500 includes a chart recorder 502, an ultrasonic flaw detector 502, a multiplexer 504, and gain control modules 506, 508, 510 and 512. The gain control module 506 will be connected to paintbrush transducers 514 that are used for the detection of a longitudinal flaw 516 on a tubular 518 with a six-inch helix. The gain control module 508 has four individual paintbrush transducers 520 used for the detection of the longitudinal flaw 516 from the same side of the tubular 518. The gain control module 510 will have four individual paintbrush transducers 526 that are used for the detection of the longitudinal flaw 516 on the opposite side of the tubular with a six inch helix. The gain control module 512 will include eight individual paintbrush transducers 528 that also detect longitudinal flaws on the opposite side of the tubular 518 with a six-inch helix.

Paintbrush transducers with rectangular-shaped transducer elements can have a wider effective beam width. For example, if using a paintbrush transducer with a 0.25″×2.0″ element, the transducer would be used in the transducer inspection assembly with a longer length of the element positioned parallel to the longitudinal axis of the tubular in order to detect longitudinally-oriented flaws. Since one or more 0.5 inch transducers are used for the detection of longitudinal flaws in tubular, either a round element (as preferred in the United States) or a square element (preferred in Europe) is used. The area of the eight 0.5 inch square shaped transducer element that the flaw detector pulses is the same as four paintbrushes 0.25 inch×2.0 inch transducer elements.

The paintbrush transducers 514, 520, 526 and 528 are positioned to provide at least 100% coverage when using the suggested effective beam width of the transducers. The arrangement of the transducers is in a typical manner as in the prior drawings using the parallel pulsing method. By using the paintbrush transducers, the number of transducers that are required to produce a helix sufficient to match the electromagnetic inspections will be reduced while maintaining the desirable pulse density and total scan time per tubular. Therefore, when inspecting larger nominal outside diameter tubulars, larger transducers and/or paintbrush transducers can be used.

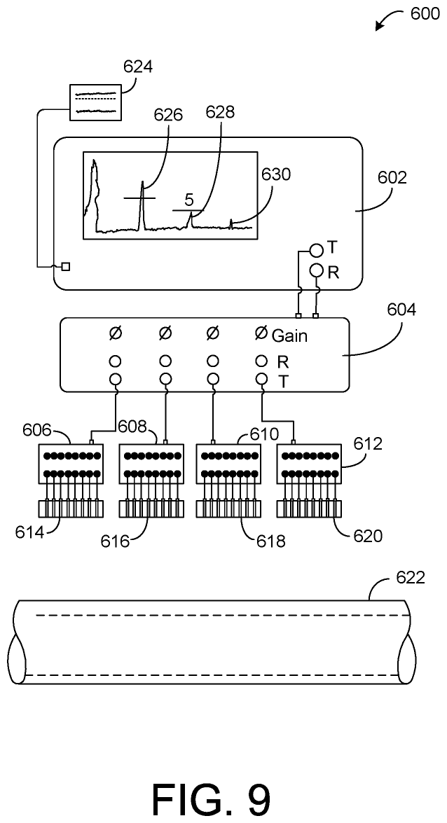

FIG. 9 illustrates an ultrasonic wall thickness inspection system 600 incorporating the concept of the present invention. In particular, system 600 includes an ultrasonic flaw detector 602, a four channel sequencing multiplexer 604, gain control modules 606, 608, 610 and 612. Each of the gain control modules 606, 608, 610 and 612 are respectively connected to ultrasonic transducer assemblies 614, 616, 618 and 620. The ultrasonic transducer assembly 614, 616, 618 and 620 are directed toward the exterior surface of the tubular 622. The ultrasonic flaw detector 602 will be connected to a strip chart recorder 624 in the manner of the previous embodiments of the present invention.

FIG. 9 shows that these that the ultrasonic flaw detector 602 has a single gate 4 and/or dual gates 4 and 5. Gate 4 can detect an insufficient wall thickness and display this indication on the chart recorder 624. Gate 5 can detect an even thinner wall thickness and display this indication on the chart recorder 624. Back wall reflects 626, 628 and/or 630 will move into the alarm gate(s) when the wall thickness changes beyond established standardization parameters.

Ultrasonic transducers used for wall thickness are typically a higher frequency transducer, for instance 5 MHz (instead of 2.25 MHz) and are typically immersion transducers. Each transducer inspection assembly is configured, a known fashion, the parallel pulsing instead of sequence pulsing. Each of the four ultrasonic transducer assemblies 614, 616, 618 and 620 will contain eight transducers per assembly, as shown in FIG. 9. This results in a three inch helix per transducer inspection assembly for a combined helix of twelve inches. The use of paintbrush transducers would substantially reduce the number of required transducers to provide a helix that matches the required helix of the inspection functions.

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

I claim:

1. A flaw detection system comprising:
a plurality of ultrasonic flaw detectors adapted to pass pulsed ultrasonic signals;
a plurality of sequencing multiplexers electrically connected to said plurality of ultrasonic flaw detectors so as to receive the pulsed ultrasonic signals from said plurality of ultrasonic flaw detectors respectively;
a plurality of gain control modules connected respectively to said plurality of sequencing multiplexers, each of said plurality of gain control modules having an output that is a multiple of an input from said plurality of sequencing multiplexers; and
a plurality of transducer assemblies respectively connected to the output of said plurality of gain control modules said plurality of transducer assemblies adapted to pass the pulsed ultrasonic signals from said plurality of gain control modules toward an object to be inspected, said plurality of transducer assemblies receiving signals from the object and passing the received signals back to said plurality of ultrasonic flaw detectors.

2. The flaw detection system of claim 1, further comprising:
a multi-channel strip chart recorder connected to said plurality of ultrasonic flaw detectors, said multi-channel strip chart recorder producing a humanly perceivable indication of a flaw in the object to be inspected.

3. The flaw detection system of claim 1, wherein each of said plurality of ultrasonic flaw detectors has a first alarm gate and a second alarm gate, the first alarm gate reacting to a first condition on the object to be inspected, the second alarm gate reacting to a second condition in the object to be inspected.

4. The flaw detection system of claim 3, wherein the first condition is an external flaw in the object to be inspected, the second condition being an internal flaw in the object to be inspected.

5. The flaw detection system of claim 3, wherein the first condition is a thickness of the object to be inspected, the second condition being another thickness in the object to be inspected.

6. The flaw detection system of claim 1, wherein the pulsed ultrasonic signals are at least 400 volt pulsed signals.

7. The flaw detection system of claim 1, wherein said plurality of ultrasonic flaw detectors comprise at least two detectors.

8. The flaw detection system of claim 2, wherein said plurality of ultrasonic flaw detectors each has a line extending to said multi-channel strip chart recorder.

9. The flaw detection system of claim 1, wherein said plurality of sequencing multiplexers comprise at least two multiplexers, each of the at least two multiplexers being connected by cable to each of said plurality of ultrasonic flaw detectors.

10. The flaw detection system of claim 1, wherein said plurality of gain control module passes the pulsed ultrasonic signal into a plurality of multi-channel parallel pulses to said plurality of transducer assemblies.

11. The flaw detection system of claim 10, wherein the plurality of multi-channel parallel pulses comprise at least four outputs from the each of said plurality of gain control module.

12. The ultrasonic flaw detection system of claim 11, wherein said plurality of transducer assemblies comprise at least four transducer assemblies, each of the at least four transducer assemblies directing the eight outputs from said plurality of gain control modules toward the object to be inspected.

13. The flaw detection system of claim 12, wherein the plurality of multi-channel parallel pulses are of the same size and have identical incident angles and refraction angles with respect to the object to be inspected.

14. The flaw detection system of claim 1, wherein the object to be inspected is a tubular, the flaw detection system further comprising:
a couplant directed to a surface of the tubular in an area between the plurality of transducer assemblies and the surface of the tubular.

15. The flaw detection system of claim 14, further comprising:
a helixing conveyor receiving the tubular therein, said helixing conveyor adapted to rotate the tubular as the plurality of transducer assemblies direct the pulsed ultrasonic signals toward the tubular.

16. The flaw detection system of claim 14, wherein the received signals from the tubular are indicative of a flaw in an external surface of the tubular or a flaw in the internal surface of the tubular.

17. The flaw detection system of claim 16, wherein the flaw in the external surface of the tubular or the flaw in the internal surface of the tubular is a transverse flaw or a longitudinal flaw or an oblique flaw in the tubular.

18. A system for detecting a flaw in a tubular, the system comprising:
a helixing conveyor adapted to rotate the tubular, said helixing conveyor having a surface upon which the tubular is removably placed;
a plurality of ultrasonic flaw detectors positioned away from said helixing conveyor, said plurality of ultrasonic flaw detectors adapted to pass pulsed ultrasonic signals;
a plurality of sequencing multiplexers electrically connected respectively to said plurality of ultrasonic flaw detectors so as to receive the pulsed ultrasonic signals from said plurality of ultrasonic flaw detectors;
a plurality of gain control modules connected respectively to said plurality of sequencing multiplexers, each of said plurality of gain control modules having an output that is a multiple of an input from said plurality of sequencing multiplexers; and
a plurality of transducer assemblies respectively connected to the outputs of said plurality of gain control modules, said plurality of transducer assemblies passing the pulsed ultrasonic signals from said plurality of sequencing multiplexers to the surface of the tubular on the helixing conveyor, said plurality of transducer assemblies receiving signals reflected from the tubular and passing the reflected signals to said plurality of ultrasonic flaw detectors, wherein said plurality of gain control modules has an input corresponding to a number of the plurality of ultrasonic flaw detectors, the output of the plurality of gain control modules being a multiple of the number of the plurality of ultrasonic flaw detectors.

19. The system of claim 18, further comprising:
a multi-channel strip chart recorder connected to said plurality of ultrasonic detectors, said multi-channel strip chart recorder producing a humanly perceivable indication of a flaw on the surface of the tubular.

20. The system of claim 18, wherein said helixing conveyor rotates the tubular as the plurality of transducer assemblies directs the pulsed ultrasonic signals toward the surface of the tubular.
